(19) United States
(12) Patent Application Publication
(10) Pub. No.: US 2002/0188030 A1
(43) Pub. Date: Dec. 12, 2002

(54) Externally emulsified aqueous resole dispersions

(76) Inventors: Peter Ziegler, Mainz (DE); Ralph Schaefer, Wiesbaden (DE); Adam Has, Mainz-Kastel (DE); Frank Scholl, Bad Homburg (DE); Johann Wonner, Rodgau (DE)

Correspondence Address: PRO PAT, L.L.C, 2912 CROSBY ROAD, CHARLOTTE, NC, 28211-2815, US

(21) Appl. No.: 10/007,016

(22) Filed: Nov. 5, 2001

(30) Foreign Application Priority Data
Jun. 8, 2001 (DE) 101 28 040.8.

(51) Int. Cl. C09K 3/00

(52) U.S. Cl. 516/70

(57) ABSTRACT

Externally emulsified aqueous resole dispersions obtained by reacting phenols and oxo compounds in the presence of an alkaline catalyst, adding an emulsifier and then dispersing in water, the catalyst used during resole formation comprising aliphatic linear, branched or cyclic tertiary monohydroxyamines having from 4 to 40 carbon atoms, and their use as binders for abrasives, particularly abrasives on backings.

### FIELD OF THE INVENTION

The invention relates to externally emulsified aqueous resole dispersions.

### BACKGROUND OF THE INVENTION

Resoles are resins formed from phenols and oxo compounds, particularly aldehydes, which when heated crosslink to an insoluble, infusible body. The raw materials used normally comprise formaldehyde or a formaldehyde donor compound in combination with phenols with or without alkyl substituents. The amount of substance of the formaldehyde used is always greater than that of the phenol; addition to the corresponding hydroxyalkylphenols takes place under alkaline conditions.

Resoles are used in solvent-free form (especially for mastics), in combination with other resins, soft resins or oils, as “plasticized resoles”, as a solution in organic solvents (as part of coating materials), and as an aqueous solution or dispersion. In the latter case, dilutability in water is achieved primarily through incorporation of hydrophilic groups such as—partly neutralized—carboxyl groups or by addition of emulsifiers.

Externally emulsified aqueous dispersions of resoles are known, for example, from U.S. Pat. No. 3,862,060, which teaches forming the resole by adding nitrogenous catalysts selected from ammonia, hexamethylenetetramine and aliphatic and aromatic amines having a molar mass of less than 300 g/mol, the ratio of the mass of the basic catalyst to the mass of the phenol being between 0.1 and 20% (i.e., from 0.1 to 20 cg/g).

In the course of the investigations that led to the present invention it was found that the resins prepared in this way, when exposed to heat (in the course of the curing process), develop a color ranging from violet to brown. This discoloration prevents the use of such aqueous resoles are binders or a binder component in coating compositions which are intended to give pale-colored coatings. The object is therefore to develop aqueous resole dispersions which do not undergo inacceptable discoloration during the curing process.

It has now been found that the discoloration of the coatings produced using aqueous resole dispersions can be reduced or eliminated entirely if tertiary monohydroxyamines are used as catalysts during the formation of the resole.

### SUMMARY OF THE INVENTION

The present invention accordingly provides an externally emulsified aqueous resole dispersion obtained by reacting phenols A with oxo compounds B in the presence of an alkaline catalyst C, adding an emulsifier D, and then forming the dispersion by incorporation of waterunderstirring, wherein aliphatic linear, branched or cyclic tertiary monohydroxyamines having from 4 to 40 carbon atoms are used as catalyst C during the formation of the resole.

The present invention further provides a process for preparing externally emulsified aqueous resole dispersions by reacting phenols A with oxo compounds B in the presence of an alkaline catalyst C, adding an emulsifier D and then adding water with stirring to form a dispersion, which comprises using aliphatic linear, branched or cyclic tertiary monohydroxyamines having from 4 to 40 carbon atoms as catalyst C during the formation of the resole.

### DETAILED DESCRIPTION OF THE PREFERRED EMBODIMENTS

The phenols A are at least difunctional with respect to oxo compounds B; that is, they possess on average at least two hydrogen atoms positioned ortho or para to the phenolic hydroxyl group. Difunctional phenols are o- and p-cresol, p-tert-butylphenol, p-tert-butyl-m-cresol, p-nonylphenol, 3,4-, 2,5-, and 2,3-xylenol, p-phenylphenol; trifunctional phenols are phenol itself, m-cresol, 3,5-xylenol, resorcinol, cardanol, and cardol; tetrafunctional phenols are, for example, bisphenol A and bisphenol F. Where phenols with a functionality of three or more are used, it is also possible to use monofunctional phenols to a minor extent (up to 20% of the mass of the phenols, preferably up to 10%), examples of such monofunctional phenols being 2,4- and 2,6-xylenol. Preference is given here to the use of (unsubstituted) phenol and also p-tert-butylphenol and p-nonylphenol.

In the context of the invention it is also possible to replace the phenols, or some of the phenols, by novolaks. It is preferred to replace up to 70% of the mass of the phenols by novolaks which are derived from phenol itself or from mixtures of one or more of the abovementioned phenols.

Among the oxo compounds B employed, preference is given to formaldehyde, which may be used in the form of an aqueous solution (formalin), as a solid (paraformaldehyde, with small fractions of water), as cyclic oligomers (trioxane, tetroxane), or in the form of formaldehyde donor compounds. The use of urotropin (hexamethylenetetramine), however, is not preferred for the present invention. Other aldehydes, such as acetaldehyde, benzaldehyde, salicylaldehyde, crotonaldehyde, glyoxal and furfural, may likewise be used; however, their use is not preferred and their mass fraction should not amount to more than 5% of the mass of formaldehyde used. The use of ketones such as acetone as oxo compounds is less preferred in the context of the present invention.

The ratio of the amounts of substance of the phenols, n(P), and of the oxo compounds, n(O), is preferably

V·n(P):n(O) from 1:0.3 to 1:1.2,

more preferably from 1:0.4 to 1:1.1, and with particular preference from 1:0.5 to 1:1.05,

where v is the (average) number of reactive sites in the phenol or in the mixture of phenols (3 in the case of phenol itself).

The aliphatic tertiary monohydroxyamines C satisfy the formula R¹R²N—R³—OH, in which R¹ and R² may be identical or different and are selected from linear, branched and cyclic aliphatic radicals having from 1 to 18 carbon atoms, preferably methyl, ethyl, n-propyl, iso-propyl, n-butyl, iso-butyl, tert-butyl, n-hexyl, 2-ethylhexyl, decyl, palmityl, and stearyl radicals, and R³ is an alkylene radical having preferably from 2 to 6 carbon atoms, preference being given to 1,2-ethylene, 1,2- and 1,3-propylene, 1,4-butylene, and 1,6-hexylene radicals. Preferred amines are N,N-dimethylethanolamine, N,N-diethanolamine, N,N-dimethylisopropanolamine, N,N-diethylisopropylamine, 1-(N,N-dimethylamino)butan-4-ol and 1-(N,N-dimethylamino)hexan-6-ol. The catalyst is preferably used in an amount such that the ratio of the mass of the catalyst C to the mass of the phenol is from 2 to 20%, more preferably from 3 to 18%, and in particular from 5 to 15%.

The emulsifiers D are preferably protein compounds, such as casein, vegetable proteins such as soy protein, for example, which are soluble in aqueous alkalis and are excellent emulsifiers for resoles. The emulsifier is preferably admixed with a basic carboxamide, such as urea, thiourea, ethyleneurea, acetyleneurea, guanidine, dicyandiamide, melamine or acetoguanamine, the mass of the amide being from 5 to 120% of the mass of the protein compound. The mass of the proteinaceous emulsifier is preferably from 1 to 10% of the mass of the resole, with particular preference from 2 to 8%.

Further suitable emulsifiers include gum arabic, gums derived from it or other gums, or, less preferably, lignin sulfate.

One of the conditions for the use of binders in the abrasives industry is rapid and bubble-free drying and curing. The resin system prepared in accordance with the invention may be used as a binder instead of, or together with, conventionally prepared phenolic resoles. Because of its rapid drying, it may also be used as an alternative to two-component systems in the area of the make coat in abrasives manufacture. Plasticization is possible within a wider range than with usual aqueous phenolic resoles, owing to their limited water-dilutability. Accordingly, the resin system prepared in accordance with the invention may be combined with acrylic dispersions or rubber dispersions, such as SBR or NBR latices, for example, in order to improve the plasticity.

For preparing coating compositions, the aqueous resole dispersions of the invention may be used alone or in combination with other aqueous resin dispersions; they are particularly suitable as binders for abrasives.

Abrasives are produced on backings using papers (mass per unit area from 70 to 320 g/m²), combinations of cloth and papers (from 600 to 1000 g/m²) or films and papers (from 100 to 300 g/m²), and also vulcanized fibers having thicknesses of from 0.4 to 0.8 mm and a mass per unit area of from 500 to 1200 g/m². Applicator rolls are used to coat the webs of the backing material with a thin film of a binder (make coat) and then the abrasive grip is scattered in (usually electrostatically). The make coat is then dried and cured in an initial drying operation. For the final fixing and embedding of the abrasive grit, a second binder film, the size coat or top coat, is applied. With phenolic resin binders, the size coat is solidified in a main drying tunnel in different temperature zones from 80 to 120° C. Drying and curing are carried out to a stage at which the material can be wound up without problems (tendency toward blocking). The rolls are brought to the final degree of curing required in a separate oven. The stepped drying temperatures are a consequence of the need for absence of bubbles. Shortening of the drying times at 90° C. has to date only been possible with two-component systems.

Very short initial drying times at 9° C. can also be realized using the aqueous resole dispersions of the invention; this is considerable progress for the throughput of the drying units.

### EXAMPLES

### Example 1

32.25 kg of phenol and 5.01 kg of a 37% strength aqueous formaldehyde solution were charged to a tank and this initial charge was heated at an internal temperature of from 65 to 70° C. 3.89 kg of dimethylethanolamine were added rapidly to this solution with thorough stirring, and the composition was held at from 65 to 70° C. with stirring for about 0.5 hour. Thereafter, at the same temperature, a further 4.93 kg of 37% strength aqueous formaldehyde solution and also 8.6 kg of paraformaldehyde (formaldehyde mass fraction approximately 91%) were added, followed by stirring for 30 minutes more. Then a further 17.56 kg of the formaldehyde solution were added in a number of portions; after the end of addition, the composition was heated to 85 to 90° C. and held at this temperature with stirring until a sample of the resin, dissolved in twice the mass of methoxypropanol, had a viscosity of approximately 350 mPa·s. The composition was then cooled to an internal temperature of approximately 55° C. A separately prepared solution of an emulsifier (2.13 kg of casein, 2.13 kg of urea, 150 g of dimethylethanolamine and 4.85 kg of water, homogenized at 30° C. for one hour) was incorporated with stirring over the course of 30 minutes. The pressure of the atmosphere above the liquid in the tank was then reduced to approximately 180 hPa (180 mbar), and 18.5 kg of deionized water were incorporated with stirring over the course of 1.5 hours, after which the tank was aerated to atmospheric pressure. The contents of the tank were held at from 50 to 60° C. for a further 5 to 6 hours until the aqueous dispersion had a viscosity of approximately 150 mPa·s (at 23° C.). Subsequently, it was cooled to below 35° C. and the contents of the vessel were discharged into a drum through a bag sieve (pore diameter 150 μm).

### Example 2

To determine bubble-free curing (reaction bubbles), a 200 μm film of a commercially customary aqueous phenolic resole (viscosity approximately 400 mPa·s, mass fraction of solids (nonvolatile fractions) approximately 74%, water-dilutability 1:>1) was knifecoated onto a backing material (vulcanized fiber, dimensions 10×12 cm²), strewn with an excess of abrasive corundum grit (F 16, DIN 69101) (the excess was subsequently discarded), and presolidified at 90° C. for 1 h and then at 120° C. for 30 minutes. The test resin was applied to the sample body (addon approximately 650 g/m²) using a rubber roller (hardness: 30 Shore A). The sample bodies were dried at 90° C. for different times (120, 90, 75, and 60 minutes) and subsequently heated at 130° C. A measurement was made of the initial drying time at 90° C. which was necessary in order for the sample to cure subsequently without bubbles at 130° C. With a standard resin (as above), from 120 to 90 minutes were needed for this to be the case. The resin system prepared in Example 1 in accordance with the invention required an initial drying time at 90° C. of less than 60 minutes for bubble-free curing.

The water-dilutability was determined by taking 5 g of the resin solution and gradually adding water, with stirring, until the mixture became turbid. The water-dilutability was then reported as a ratio of mass of the resin solution (in supply form) to the mass of the water added before the mixture turned turbid.

### Example 3

To determine the drying rate, a defined amount (1.5 ml) of the test resin solution was applied to a heated hotplate (plane-ground). To assess the drying, the stringing of the sample was assessed in accordance with the recognition of the endpoint in the B-stage measurement (DIN EN ISO 8987), recording the time until the string tore. For the abovementioned standard resin, a drying time at 90° C. of approximately 80 minutes was found. The resin system prepared in Example 1 in accordance with the invention had dried after just 20 minutes at 90° C.

1. An externally emulsified aqueous resole dispersion obtained by reacting phenols A with oxo compounds B in the presence of an alkaline catalyst C, adding an emulsifier D, and then dispersing in water, wherein aliphatic linear, branched or cyclic tertiary monohydroxyamines having from 4 to 40 carbon atoms are used as catalyst C during the formation of the resole.

2. The externally emulsified aqueous resole dispersion as claimed in claim 1, wherein monohydroxyamines selected from the group consisting of N,N-dimethylethanolamine, N,N-diethanolamine, N,N-dimethylisopropanolamine, N,N-diethylisopropylamine, 1-(N,N-dimethylamino)butan-4-ol, and 1-(N,N-dimethylamino)hexan-6-ol are used as catalyst C in forming the resole.

3. The externally emulsified aqueous resole dispersion as claimed in claim 1, wherein the phenols A are selected from the group consisting of phenol, p-tert-butylphenol and p-nonylphenol.

4. The externally emulsified aqueous resole dispersion as claimed in claim 1, wherein the oxo compound B is formaldehyde.

5. The externally emulsified aqueous resole dispersion as claimed in claim 1, wherein the emulsifier D comprises casein or soy protein.

6. A process for preparing an externally emulsified aqueous resole dispersion as claimed in claim 1, which comprises reacting phenols A with oxo compounds B in the presence of an alkaline catalyst C, adding an aqueous solution of an emulsifier D, and then dispersing the reaction composition in water, which comprises using aliphatic linear, branched or cyclic tertiary monohydroxyamines having from 4 to 40 carbon atoms as catalyst C during the formation of the resole.

7. The process as claimed in claim 6, wherein monohydroxyamines selected from the group consisting of N,N-dimethylethanolamine, N,N-diethanolamine, N,N-dimethylisopropanolamine, N,N-diethylisopropylamine, 1-(N,N-dimethylamino)butan-4-ol and 1-(N,N-dimethylamino)hexan-6-ol are used as catalysts.

8. The process as claimed in claim 6 wherein a mixture of proteinaceous emulsifier and a carboxamide selected from urea, ethyleneurea, acetyleneurea, guanidine, dicyandiamide, melamine and acetoguanamine is used as emulsifier.

9. The process as claimed in claim 6, wherein the emulsifier D comprises casein or soy protein.

10. A method of use of an externally emulsified aqueous resole dispersion as claimed in claim 1, as binders for abrasives on flat backings, comprising applying the said resole dispersion as make coat to a substrate selected from the group consisting of paper, combinations of paper and woven fabric, films and paper, and vulcanised fiber, scattering in the abrasive grit, pre-drying and curing.
